(19) United States
(12) Patent Application Publication
(10) Pub. No.: US 2026/0313291 A1
(43) Pub. Date: Oct. 8, 2026

(54) AUDIO ADJUSTMENTS IN A VEHICLE BASED ON USER TRACKING

(71) Applicant: HARMAN BECKER AUTOMOTIVE SYSTEMS, INC., Novi, MI (US)

(72) Inventor: Christopher Michael TRESTAIN, Livonia, MI (US)

(21) Appl. No.: 19/098,320

(22) Filed: Apr. 2, 2025

(51) Int. Cl. H04R 1/32

(52) U.S. Cl. CPC H04R 1/323; H04R 2499/13

(57) ABSTRACT

Various embodiments disclose a computer-implemented method that can include determining a first audio focal point in a vehicle at a first instant in time, configuring at least one parameter of an audio output of a first speaker in the vehicle to produce a specific sound effect at the first audio focal point, determining a second audio focal point in the vehicle at a second instant in time, and modifying the at least one parameter of the audio output of the first speaker to produce the specific sound effect at the second audio focal point in the vehicle. The parameter of the audio output of the first speaker can be a volume, a delay, a phase characteristic, or a spectral characteristic. The specific sound effect can be a surround sound effect, an environmental sound effect, a directional sound effect, a tailored frequency effect, a reverb effect, or an echo effect.

### BACKGROUND

### Field of the Various Embodiments

The various embodiments relate generally to performing audio adjustments in a vehicle and, more specifically, to performing audio adjustments in a vehicle based on user tracking.

### Description of the Related Art

Vehicle manufacturers typically provide various features for audio systems integrated into vehicles. For example, audio systems can provide user controls for producing a personally desired sound quality. The audio system can also include the capability to automatically tailor certain qualities of the sound produced by the audio system in order to provide an enhanced listening experience. For example, a vehicle audio system can include various kinds of controls for performing operations such as volume control, tone control, input source selection, music track selection, and radio station selection. A volume control can be used by a listener to modify an overall sound volume produced by a set of speakers in the vehicle. A balance control can be used to further set a sound volume produced by a left channel speaker of the set of speakers to be different than that produced by a right channel speaker. A fader control can be used to set a sound volume produced by a pair of rear mounted speakers to be different than that produced by a pair of front mounted speakers.

Furthermore, a conventional vehicle audio system can include built-in circuitry that automatically controls various aspects related to sound produced by the audio system. Such circuitry can automatically implement features such as noise reduction, volume control based on ambient noise, tailored sound suitable for various types of speakers, and tailored sound for various types of sound effects. Tailoring sound for various types of speakers can include tailoring frequency characteristics of each of multiple sound channels. For example, high frequency components contained in a sound channel provided to a woofer can be attenuated. Conversely, low frequency components contained in a sound channel provided to a tweeter can also be attenuated. Tailoring for various types of sound effects can include tailoring sound for producing a surround sound effect, an environmental effect (theater, hall, sports stadium, etc.), or a directional effect (primarily directed towards driver, for example).

One drawback associated with conventional audio systems, especially with reference to built-in features, is a one-size-fits-all approach that is used to implement various features. For example, a sound quality of a conventional vehicle audio system is often calibrated by use of a test dummy referred to as a “head and torso simulator” (HATS). The head and torso simulator is typically a mannequin that is configured to mimic human response to audio signals in a vehicle and includes various sensors (microphones, pressure sensors, etc.) for doing so. The test dummy typically conforms to standardized size parameters (height, mass, size of various limbs, etc.) and is placed in a vehicle in a standardized position and posture (seated in a driver seat and leaning forward in a particular driving posture, for example). Various settings of the driver seat (distance from steering wheel, height, tilt angle, etc.) on which the test dummy is placed are generally set in accordance with size parameters of the test dummy. However, different drivers have different physical characteristics and are seated at varying distances, heights, and/or tilt angles with reference to the steering wheel of a vehicle. Consequently, a vehicle audio system that is calibrated by use of a conventional test dummy can produce sound characteristics that are unsuitable or undesirable by different types of drivers.

As the foregoing illustrates, what is needed in the art are more effective techniques for adaptive tailoring of various features of a vehicle audio system in accordance with physical characteristics and behaviors of a variety of occupants of a vehicle.

### SUMMARY

In various embodiments, a computer-implemented method comprises determining a first audio focal point in a vehicle at a first instant in time, configuring at least one parameter of an audio output of a first speaker in the vehicle to produce a specific sound effect at the first audio focal point, determining a second audio focal point in the vehicle at a second instant in time, and modifying the at least one parameter of the audio output of the first speaker to produce the specific sound effect at the second audio focal point in the vehicle. The parameter of the audio output of the first speaker can be, for example, at least one of a volume, a delay, a phase characteristic, or a spectral characteristic. The specific sound effect can be, for example, a surround sound effect, an environmental sound effect, a directional sound effect, a tailored frequency effect, a reverb effect, or an echo effect.

At least one technical advantage of the disclosed techniques herein relative to the prior art is that, with the disclosed techniques, a quality of sound produced by a vehicle audio system can be tailored in accordance with different physical attributes and seat-related positional preferences of an occupant of a vehicle. More particularly, the quality of sound produced by a vehicle audio system can be tailored in real time to various individuals who can be seated in a vehicle seat at various times and in various positions and postures. Another technical advantage provided by disclosed techniques is the capability to flexibly personalize a vehicle audio system to specifically cater to an occupant of the vehicle after the audio system has been initially calibrated in a standardized manner. Another technical advantage of the disclosed techniques includes the capability to flexibly personalize a vehicle audio system to cater to multiple occupants of a seat of a vehicle at any of various times. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of an example audio system configured to implement one or more aspects of the present disclosure;

FIG. 2 illustrates a first example scenario associated with performing audio adjustments in a vehicle based on factors such as movement, posture, or size of an individual, according to various embodiments;

FIG. 3 illustrates a second example scenario associated with performing audio adjustments in a vehicle based on factors such as movement, posture, or size of an individual, according to various embodiments; and

FIG. 4 is a flow diagram of method steps for performing audio adjustments in a vehicle based on factors such as movement, posture, or size of an individual, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details. For explanatory purposes, multiple instances of like objects are symbolized with reference numbers identifying the object and parenthetical numbers identifying the instance where needed.

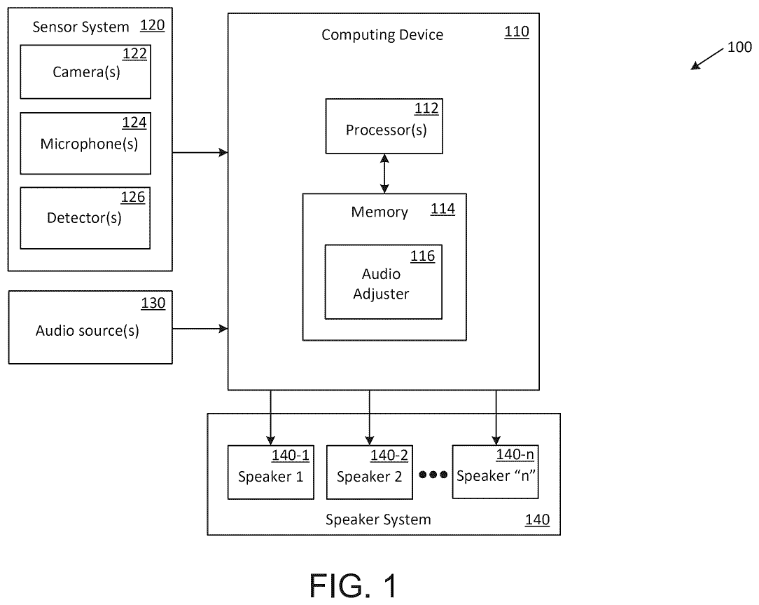

FIG. 1 illustrates a block diagram of an example vehicle audio system 100 configured to implement one or more aspects of the present disclosure. As shown, the vehicle audio system 100 includes, without limitation, a computing device 110, a sensor system 120, audio source(s) 130, and a speaker system 140. Computing device 110 includes, without limitation, one or more processors such as processor(s) 112, and further includes one or more memories such as a memory 114. The memory 114 includes, without limitation, an audio adjuster 116.

The sensor system 120 includes, without limitation, various types of devices such as one or more camera(s) 122, one or more microphone(s) 124, and one or more detector(s) 126. Camera(s) 122 can be mounted at various locations inside a vehicle such as on a top section of the front windshield, on a rear-view mirror attached to the front windshield, on one or more side pillars, on a headrest portion, and/or on a roof of the cabin. Each of camera(s) 122 is configured to capture images (digital snapshots, video clips, real time video, etc.) of one or more occupants of the vehicle such as a driver of the vehicle. The images can be evaluated by the computing device 110 to determine various physical characteristics (torso size, head size, height, etc.) and sitting postures (distance from steering wheel, angle information of head, angle information of body, ear position, ear tilt, etc.) of the driver.

Microphone(s) 124 can be mounted at various locations inside the vehicle and arranged to capture various types of sounds in the cabin of the vehicle. In an example implementation, a pair of microphones are provided in a headrest of a driver seat and are arranged to provide audio information to the computing device 110. The audio information includes, for example, a sound quality in a spatial location in the proximity of each ear of the driver and/or in a spatial area around the head of the driver.

Detector(s) 126 can be any of various types of devices such as pressure sensors, object detectors, location sensors, accelerometers, and/or gyroscopic devices. Detector(s) 126 are mounted at any of various locations inside the vehicle. The various detectors 126 are configured to provide various types of information to the computing device 110. Such information includes, for example, various positions of the driver seat and/or various actions performed by the driver (head movements, body movements, etc.) at various instants in time and/or over various periods of time. A radar is one example detector configured to provide information related to parameters such as location of an object, presence of an object, and distance measurements. In an example implementation, one or more radar devices are mounted in a driver seat headrest and configured to provide information pertaining to separation distance between an ear of the driver and one or more speakers provided in the vehicle. A light detection and ranging (LIDAR) device is another example detector that can provide information related to parameters such as a separation distance between an ear of a driver and various objects in a vehicle. In an example implementation, one or more LIDARs can be mounted in a driver seat headrest and configured to provide information pertaining to separation distance between an ear of the driver and one or more speakers provided in the vehicle.

The audio source(s) 130 can include without limitation, one or more of a broadcast radio system, a satellite radio system, a smartphone, an auxiliary streaming audio device, a streaming service, and/or the like. The various signal sources can be connected to the computing device 110 either wirelessly or via cables. Any of the signal sources can be selectively coupled into the computing device 110. In an example implementation, a driver of a vehicle can operate a selector switch to select one of the audio source(s) 130 for playback via the computing device 110.

Speaker system 140 includes, without limitation, speakers 140-1 through 140-n (n≥2). The “n” speakers, which can be any technically feasible speaker that converts electrical signals into sound, are generally configured to produce sound inside the cabin of the vehicle, can be provided at various locations in a vehicle. For example, a first pair of speakers can be mounted in a front portion of the vehicle (in the dashboard, for example), a second pair of speakers can be mounted in a rear portion of the vehicle (in a rear panel next to a rear window, for example), a third pair of speakers can be mounted in a door panel of the vehicle, and a fourth pair of speakers can be mounted in a headrest of the driver's seat.

The computing device 110 generally performs various operations upon the selected one of the signal sources of the audio source(s) 130 and couples output signals into the “n” speakers of the speaker system 140. The processor(s) 112 can include one or more central processing units (CPUs), digital signal processing units (DSPs), microprocessors, application-specific integrated circuits (ASICs), neural processing units (NPUs), graphics processing units (GPUs), field-programmable gate arrays (FPGAs), and so forth. The processor(s) 112 generally includes a programmable processor that executes program instructions to manipulate input data and generate outputs. In some embodiments, the processor(s) 112 can include any number of processing cores, and other modules for facilitating program execution.

The memory 114 includes a memory module or collection of memory modules. The memory 114 generally comprises storage chips such as, for example, random-access memory (RAM) chips that store application programs and data for processing by the processor(s) 112. In various embodiments, the memory 114 includes non-volatile memory such as optical drives, magnetic drives, flash drives, or other storage. The audio adjuster 116 that can be stored in the memory 114 in the form of a software application is executed by the processor(s) 112 to implement various operations in accordance with various embodiments of the disclosure. Such operations include adaptively tailoring various parameters of sound output produced by one or more speakers of the vehicle audio system 100 to match physical characteristics and behaviors of occupants of a vehicle. As indicated above, a vehicle audio system that is calibrated by use of a conventional test dummy can produce sound characteristics that are unsuitable or undesirable by different types of drivers. Different drivers can have different physical characteristics and can adjust a driver's seat to conform to individual taste such as a distance, an elevation, and/or a tilt angle of the driver's seat with respect to a steering wheel of the vehicle. Accordingly, audio adjuster 116 flexibly personalizes a vehicle audio system to cater to multiple occupants of a seat of a vehicle at any of various times.

In an example embodiment, audio adjuster 116 determines a first audio focal point in a vehicle at a first instant in time. The first audio focal point corresponds to a localized space inside a vehicle where an audio signal produced by a speaker in the vehicle has a specific sound effect that is associated with a desired listening experience. In an example scenario, the first audio focal point is a calibration reference position corresponding to an area around a head portion of a HATS dummy placed upon a driver seat. In this scenario, the first audio focal point is determined during a calibration procedure performed by a manufacturer of the vehicle.

In another example scenario, the first audio focal point corresponds to an area around a head of a driver seated in a driver seat or a passenger seated in another location in the vehicle, and more particularly in the vicinity of an ear of the driver or passenger. One or more parameters of an audio output of a first speaker in the vehicle is adjusted to produce a specific sound effect at this first audio focal point. For example, the audio output of a front right speaker is adjusted to produce the specific sound effect in the right ear of the driver. The various parameter(s) that can be adjusted include a volume, a delay, a phase characteristic, and/or a spectral characteristic. The specific sound effect can be a surround sound effect, an environmental sound effect, a directional sound effect, a tailored frequency effect, a reverb effect, or an echo effect. In an example scenario, the volume of sound produced by a speaker can be increased upon determining that the first audio focal point is located beyond a first preset threshold distance from the speaker. Conversely, the volume can be reduced upon determining that the first audio focal point is located less than a second preset threshold distance from the speaker. The delay can be adjusted to produce a desired sound effect at the first audio focal point. An example sound effect is a reverb effect which adds a spaciousness to the sound at the first audio focal point. An echo effect can simulate sound bouncing off one or more objects in the vehicle. Adjusting a spectral characteristic such as by enhancing certain sound frequencies (bass frequencies, for example) and attenuating some other sound frequencies (treble frequencies, for example) can produce a desired spectral response in sound at the first audio focal point. An environmental sound effect (theater, hall, sports stadium, etc.) can be produced by combining a delay, a phase characteristic, and a tailored spectral characteristic.

Further operations include determining a second audio focal point in the vehicle at a second instant in time. Determining the second audio focal point can be performed by the audio adjuster 116 based on one or more inputs from one or more components of the sensor system 120. In an example scenario, the second audio focal point corresponds to an area around the head of the driver after the driver has performed one or more actions such as leaning back and resting his/her head upon the head rest and/or adjusting the driver seat after entering the vehicle and sitting in the driver seat. After determining the second audio focal point, the parameter(s) of the audio output of the first speaker that was adjusted earlier for the first audio focal point is readjusted so as to produce the specific sound effect at the second audio focal point. In the example scenario indicated above, the audio output of the front passenger-side speaker can be adjusted to produce the specific sound effect in the repositioned right ear of the driver.

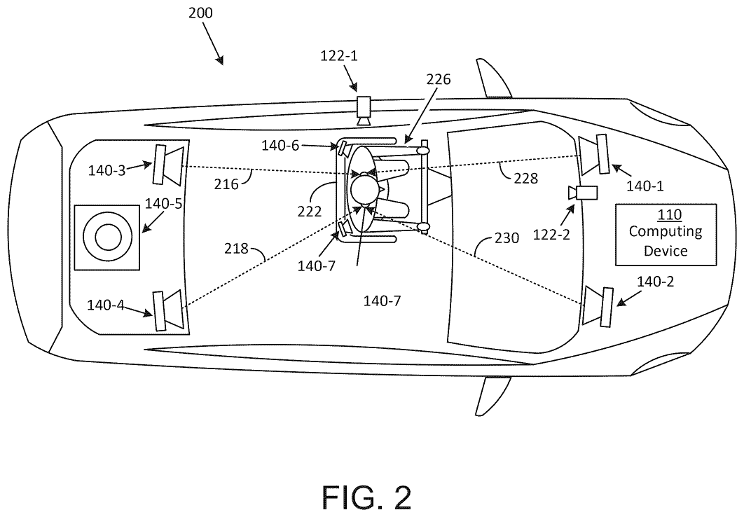

FIG. 2 illustrates a first example scenario associated with performing audio adjustments in a vehicle 200 based on factors such as movement, posture, or size of an individual, according to various embodiments. The audio adjustments can be performed by the computing device 110 by executing the audio adjuster 116. The description below, which is made with reference to a driver 226 seated in a driver seat 222 of the vehicle 200, is equally applicable to a HATS dummy placed on the driver seat 222 in lieu of the driver 226 and is also applicable to any other occupant of the vehicle 200 seated in any other seat in the vehicle 200.

In an example implementation, the audio adjustments described below that are performed with the driver 226 seated in the vehicle 200 are carried out after the vehicle 200 has left a test facility or a manufacturing facility where a calibration procedure has been performed by use of a HATS dummy. In another example implementation, the audio adjustments described below are carried out without the calibration procedure having been performed earlier.

The speaker system of the vehicle 200 includes a pair of front speakers (speaker 140-1 and speaker 140-2), a pair of rear speakers (speaker 140-3 and speaker 140-4), a pair of speakers (speaker 140-6 and speaker 140-7) mounted in a headrest portion of the driver seat 222, and a subwoofer 140-5 in the trunk of the vehicle 200. In other implementations, the vehicle 200 can include more than, or less than, the illustrated seven speakers.

In operation, the audio adjuster 116 adaptively tailors various parameters of sound output produced by one or more speakers of the vehicle 200 to match physical characteristics and behaviors of one or more occupants of the vehicle 200.

In an example implementation, the audio adjuster 116 determines a location of one or both ears of the driver 226. The audio adjuster 116 determines a location of a right ear of the driver 226. The determination is made by the audio adjuster 116 based on signals received from one or more cameras mounted in the cabin of the vehicle 200 and/or from one or more sensors of the sensor system 120 such as signals received from a LIDAR mounted in the headrest of the driver seat 222. In one scenario, one or more images are received from a camera 122-2 that is mounted on a dashboard or a rear-view mirror of the vehicle 200 and/or from a camera 122-1 mounted on a driver-side pillar of the vehicle 200.

The location of the right ear of the driver 226, which is referred to herein as being located at a first audio focal point, can be defined in various ways such as by use of a spatial 3D format using cartesian coordinates (x, y, and z coordinates). In another implementation, the audio adjuster 116 determines a location and/or a posture of the head of the driver 226. The posture of the head of the driver 226 can be used to not only determine a position of one or both ears of the driver 226 but also an orientation of one or both ears of the driver 226 with reference to one or more speakers in the vehicle 200 (for example, yaw, pitch, or roll parameters of an ear).

The audio adjuster 116 obtains information about a location of a speaker in the vehicle 200 such as a location of the speaker 140-2. The location of the speaker 140-2 can be defined in an absolute position format or in a relative position format. The absolute position format can be a spatial 3D format using cartesian coordinates (x, y, and z coordinates). The relative position format can be used to define a position of the speaker 140-2 with reference to the driver seat 222. In an example implementation, location information of the speaker 140-2 is stored in a database (not shown) in the computing device 110. The database can further include information about other speakers and various components of the vehicle 200. Such information can be obtained from a manufacturer of the vehicle 200.

The audio adjuster 116 can then determine a positional relationship 230 that is illustrated in the form of an axis of travel of the audio output of the speaker 140-2 to the right ear of the driver 226. The positional relationship 230 can be defined in any of various ways such as, in the form of a vector parameter, a scalar parameter, or a polar parameter. The positional relationship 230 is used by the audio adjuster 116 to configure one or more parameters of an audio output of the speaker 140-2 to produce a specific sound effect in the right ear of the driver 226 seated in the illustrated position. Example parameters can include a volume, a delay, a phase characteristic, and/or a spectral characteristic.

Configuring the parameters of the audio output of the speaker 140-2 (and of other speakers in the vehicle 200) is carried out by the audio adjuster 116 based on associating various audio focal points to various audio parameters. In an example implementation, a look-up table is provided that contains a mapping of various audio focal points to various audio parameters. The look-up table can be populated based on, for example, a learning procedure, a calibration procedure, and/or on use of an artificial intelligence (AI) tool.

The procedure described above with respect to determining a location of the first audio focal point and configuring an audio output of the speaker 140-2 can be replicated to configure one or more parameters of an audio output of the speaker 140-1 to produce a specific sound effect in the left ear of the driver 226. The location of the left ear of the driver 226 (referred to herein as a second audio focal point) can be defined in various ways such as based on a spatial 3D format using Cartesian coordinates (x, y, and z coordinates).

In an example implementation, the parameter(s) of the audio output of the speaker 140-1 is modified in inverse proportion to the parameter(s) of the audio output of the speaker 140-2. For example, a volume of the audio output of the speaker 140-1 is reduced in inverse proportion to an increase in volume of the audio output of the speaker 140-2, and vice-versa. A phase of the audio output of the speaker 140-1 can be shifted in inverse proportion to a change in phase delay of the audio output of the speaker 140-2. In another example implementation, the parameter(s) of the audio output of the speaker 140-1 is set to match the parameter(s) of the audio output of the speaker 140-2. For example, the spectral characteristics of the audio output of the speaker 140-1 is modified to match the spectral characteristics of the audio output of the speaker 140-2 (for example, by use of a frequency equalizer to increase high frequency content and/or suppress low frequency content in both speakers).

The procedure described above can be carried out to configure one or more parameters of an audio output of one or more other speakers in the vehicle 200, either based on the modification of the parameter(s) of the audio output of the speaker 140-1 and/or the speaker 140-1, or independent of the audio output of the speaker 140-1 and/or the speaker 140-1. For example, one or more parameters of an audio output of the pair of rear speakers (speaker 140-3 and speaker 140-4) and/or of the pair of headrest speakers (speaker 140-6 and speaker 140-7), can be modified in accordance to the modification of the sound parameters of the pair of front speakers (speaker 140-1 and speaker 140-2) so as to produce a surround sound effect in the ears of the driver 226. More particularly, one or more parameters of an audio output of the speaker 140-3 can be modified based on the positional relationship 230, and one or more parameters of an audio output of the speaker 140-4 can be modified based on the positional relationship 218.

An overall sound effect produced in the ears of the driver 226 as a result of the configurations performed upon the various parameters of the audio outputs of the various speakers can be, for example, a surround sound effect, an environmental sound effect (theater, hall, sports stadium, etc.), a directional sound effect, a tailored frequency effect, a reverb effect, or an echo effect.

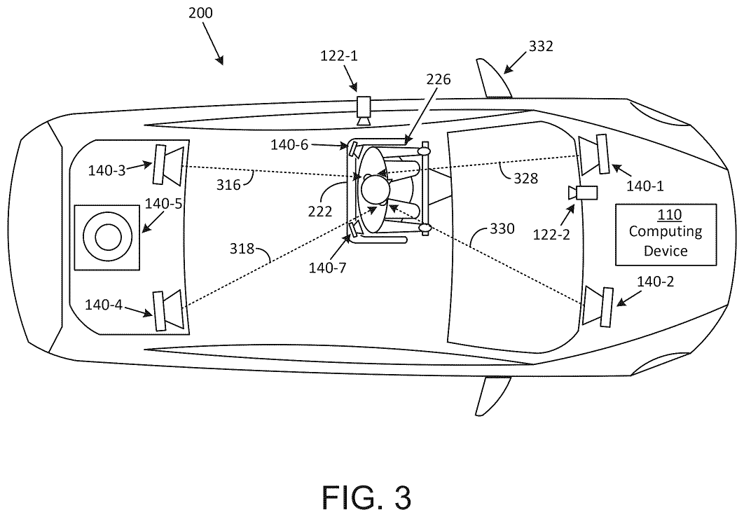

FIG. 3 illustrates a second example scenario associated with performing audio adjustments in the vehicle 200 based on factors such as movement, posture, or size of an individual, according to various embodiments. The audio adjustments are performed by the computing device 110 based on executing the audio adjuster 116. The description below, which is made with reference to the driver 226 seated in the driver seat 222 of the vehicle 200, is equally applicable to any other person seated in the driver seat 222. For example, the other person can have different physical characteristics (height, posture, etc.) and different seating preferences than the driver 226 shown in FIG. 2. In this case, the other person may adjust the driver seat 222 to a different position than the driver 226 (elevation, tilt, distance with respect to steering wheel, etc.).

Driver 226 in illustrated form has moved the driver seat 222 closer towards the steering wheel of the vehicle 200 and is looking in a different direction than that illustrated in FIG. 2. In this scenario, the driver 226 has swiveled his/her head to look in the direction of a side view mirror 332 of the vehicle 200. Swiveling of the head and repositioning of the driver seat 222 causes the positional relationship 316, the positional relationship 318, the positional relationship 328, and the positional relationship 330, to be different than the positional relationship 216, the positional relationship 218, the positional relationship 228, and the positional relationship 230, respectively, that are shown in FIG. 2.

The audio adjuster 116 adaptively tailors various parameters of sound output produced by one or more speakers of the vehicle 200 to match physical characteristics and behaviors of the driver 226 in his/her modified seat position and head position. In an example implementation, the various parameters are modified in real time to conform to head and/or body movements of the driver 226. The head and/or body movements can include, for example, leaning forward, leaning back, bobbing the head, swiveling the head in various directions, and/or tilting the head at various angles.

The adaptive tailoring of the various parameters of sound produced by one or more speakers of the vehicle 200 can be performed at various times such as in real-time, periodically, intermittently, or on as-needed basis. Thus, in one implementation, the adaptive tailoring of the various parameters of sound produced by one or more speakers of the vehicle 200 are performed by the audio adjuster 116 every time a movement of the head of the driver 226 exceeds one or more preset threshold parameters (extent of movement, type of movement, etc.). In another implementation, the adaptive tailoring of the various parameters of sound produced by one or more speakers of the vehicle 200 are performed by the audio adjuster 116 upon detecting a change in occupancy of a seat such as when the driver 226 exits the vehicle 200 and another person occupies the driver seat 222 (on another day, for example). The change in occupancy is detected, for example, by evaluating one or more images captured by one or more cameras in the vehicle 200.

More particularly, with reference to the change in posture and seat position of the driver 226 shown in FIG. 3, the audio adjuster 116 performs various operations based on evaluating images received from the camera 122-2 and camera 122-1. For example, the audio adjuster 116 determines a decrease in separation distance between the right ear of the driver 226 and the front speaker 140-2 (illustrated in FIG. 3 by the positional relationship 330) based on comparing to the previous separation distance between the right ear of the driver 226 and the front speaker 140-2 (illustrated in FIG. 2 by the positional relationship 230). The audio adjuster 116 then determines one or more parameters of the front speaker 140-2 that are to be changed as a result of the reduction in separation distance. In an example implementation, the audio adjuster 116 makes the determination based on referring to a look-up table that contains a mapping of various separation distances to various sound parameters. The look-up table, or another look-up table may contain a mapping of other parameters such as, for example, a mapping of various audio focal points to various sound effects (surround sound effect, environmental sound effect, directional sound effect, tailored frequency effect, reverb effect, echo effect, etc.). In the illustrated example, the audio adjuster 116 can reduce a volume of sound, increase a time delay, modify a phase shift, and/or modify a spectral content of sound produced by the front speaker 140-2 based on the mapping of various separation distances to various sound parameters. The audio adjuster 116 repeats this procedure for the other front speaker 140-1.

Conversely, the audio adjuster 116 determines an increase in separation distance between the right ear of the driver 226 and the rear speaker 140-4 (illustrated in FIG. 3 by the positional relationship 318) based on comparing to the previous separation distance between the right ear of the driver 226 and the rear speaker 140-2 (illustrated in FIG. 2 by the positional relationship 218). The audio adjuster 116 then determines one or more parameters of the speaker 140-4 that are to be changed as a result of the increase in separation distance. In an example implementation, the audio adjuster 116 makes the determination based on referring to a look-up table that contains a mapping of various separation distance to various sound parameters. For example, the audio adjuster 116 can increase a volume of sound, decrease a time delay, modify a phase shift, and/or modify a spectral content of sound produced by the speaker 140-4. The audio adjuster 116 repeats this procedure for the other front speaker 140-3.

The audio adjuster 116 can further modify one or more parameters of the sound produced by the pair of speakers 140-6 and 140-7 that are mounted in the headrest portion of the driver seat 222, based on evaluating images provided by the camera 122-1 and camera 122-2. The images can indicate an extent of change in the direction of gaze of the driver 226, which results in a change in separation distance between the ears of the driver 226 and each of the pair of speakers 140-6 and 140-7.

In an example implementation, a volume of sound produced by the sub-woofer 140-5 is left unchanged but a frequency characteristic is changed, such as, for example, low-frequency sound content is boosted to compensate for the increase in separation distance between the sub-woofer 140-5 and the driver 226.

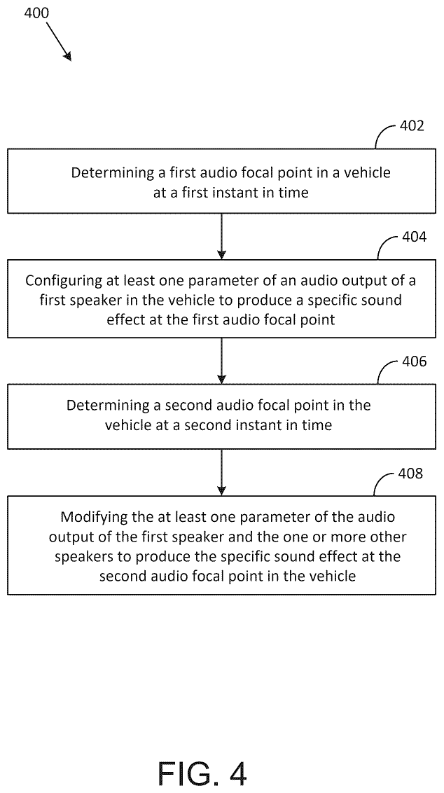

FIG. 4 is a flow diagram of method steps for performing audio adjustments in a vehicle based on factors such as movement, posture, or size of an individual, according to various embodiments. Although the method steps are described with respect to the systems of FIGS. 1-3, persons skilled in the art will understand that any system configured to perform the method steps, in any order, falls within the scope of the various embodiments.

As shown, a method 400 begins at step 402, which involves the audio adjuster 116 determining a first audio focal point at a first instance in time. In an example implementation, the first audio focal point is determined based on factors such as, for example, movement, posture, or size of the driver 226. The factors are identifiable by evaluating one or more images provided by one or more cameras such as, for example, the camera 122-1 and the camera 122-2.

In an example scenario, the first audio focal point corresponds to an area around a head portion of a HATS dummy placed upon a driver seat. In this case, the first audio focal point can be determined during a calibration procedure performed by a manufacturer of the vehicle. In another example scenario, the first audio focal point corresponds to an area around a head of a driver seated in a driver seat, and more particularly an area in the vicinity of an ear of the driver. In this case, the first audio focal point can be determined after the driver has entered the vehicle and is seated in the driver seat. In an example procedure, step 402 involves the audio adjuster 116 determining a location of a right ear of the driver 226 shown in FIG. 2. The determination can be made by the audio adjuster 116 based on images received from one or more camera and/or sensor signals received from one or more sensors of the sensor system 120 such as a LIDAR mounted in the headrest of the driver seat 222. The location of the right ear of the driver 226, which is referred to herein as a first audio focal point, can be defined in various ways such as by use of a spatial 3D format using cartesian coordinates (x, y, and z coordinates). In another implementation, the audio adjuster 116 determines a location and/or position of the head of the driver 226. The position of the head of the driver 226 (for example, a yaw, pitch, or roll of the head) can be used to not only determine a position of one or both ears of the driver 226 but also an orientation of one or both ears of the driver 226 with reference to one or more speakers in the vehicle 200.

At step 404, the audio adjuster 116 configures at least one parameter of an audio output of a first speaker in the vehicle to produce a specific sound effect at the first audio focal point. The specific sound effect can be a surround sound effect, an environmental sound effect, a directional sound effect, a tailored frequency effect, a reverb effect, or an echo effect. In an example scenario, the volume of sound produced by a speaker can be increased upon determining that the first audio focal point is located beyond a first preset threshold distance from the speaker. Conversely, the volume can be reduced upon determining that the first audio focal point is located less than a second preset threshold distance from the speaker. The delay can be adjusted to produce a desired sound effect at the first audio focal point. An example sound effect is a reverb effect which adds a spaciousness to the sound at the first audio focal point. An echo effect can simulate sound bouncing off one or more objects in the vehicle. Adjusting a spectral characteristic such as by enhancing certain sound frequencies and attenuating some other sound frequencies, can produce a desired spectral response in sound at the first audio focal point. An environmental sound effect (theater, hall, sports stadium, etc.) can be produced by combining a delay, a phase characteristic, and a tailored spectral characteristic.

At step 406, the audio adjuster 116 determines a second audio focal point at a second instance in time. In an example implementation, the second audio focal point is determined based on evaluating factors such as, for example, a movement performed by the driver 226 (moving the driver seat 222 forwards or backwards, for example), a change in posture (swiveling his/her head, sitting upright, etc.), and/or a change in size (switching drivers, for example). The factors are identifiable by evaluating one or more images provided by one or more cameras such as, for example, the camera 122-1 and the camera 122-2.

At step 408, the audio adjuster 116 modifies at least one parameter of the audio output of the first speaker to produce the specific sound effect at the second audio focal point in the vehicle. For example, the audio adjuster 116 can produce a specific sound effect in the left ear of the driver 226 based on evaluating the action performed in step 404 and determining a modification to be carried out upon at least one parameter of the audio output of the speaker 140-2. The modification can enable producing an overall sound effect in the ears of the driver 226 (a surround sound effect, an environmental sound effect, a directional sound effect, a reverb effect, an echo effect, etc.).

In sum, a computer-implemented method can include determining a first audio focal point in a vehicle at a first instant in time, configuring at least one parameter of an audio output of a first speaker in the vehicle to produce a specific sound effect at the first audio focal point, determining a second audio focal point in the vehicle at a second instant in time, and modifying the parameter of the audio output of the first speaker to produce the specific sound effect at the second audio focal point in the vehicle. In some embodiments, the parameter of the audio output of the first speaker can include a volume, a delay, a phase characteristic, and/or a spectral characteristic. The specific sound effect can be, for example, a surround sound effect, an environmental sound effect, a directional sound effect, a tailored frequency effect, a reverb effect, or an echo effect.

At least one technical advantage of the disclosed techniques herein relative to the prior art is that, with the disclosed techniques, a quality of sound produced by a vehicle audio system can be tailored in accordance with different physical attributes and seat-related positional preferences of an occupant of a vehicle. More particularly, the quality of sound produced by a vehicle audio system can be tailored in real time to various individuals who can be seated in a vehicle seat at various times and in various positions and postures. Another technical advantage provided by disclosed techniques is the capability to flexibly personalize a vehicle audio system to specifically cater to an occupant of the vehicle after the audio system has been initially calibrated in a standardized manner. Another technical advantage of the disclosed techniques includes the capability to flexibly personalize a vehicle audio system to cater to multiple occupants of a seat of a vehicle at any of various times. These technical advantages provide one or more technological improvements over prior art approaches.
1. In some embodiments, a computer-implemented method for performing audio adjustments in a vehicle based on different audio focal points in the vehicle, the computer-implemented method comprises determining a first audio focal point in the vehicle at a first instant in time, configuring at least one parameter of an audio output of a first speaker in the vehicle to produce a specific sound effect at the first audio focal point, determining a second audio focal point in the vehicle at a second instant in time, and modifying the at least one parameter of the audio output of the first speaker to produce the specific sound effect at the second audio focal point in the vehicle.
2. The computer-implemented method of clause 1, wherein the at least one parameter of the audio output of the first speaker comprises at least one of a volume, a delay, a phase characteristic, or a spectral characteristic.
3. The computer-implemented method of clauses 1 or 2, wherein the specific sound effect comprises at least one of a surround sound effect, an environmental sound effect, a directional sound effect, a tailored frequency effect, a reverb effect, or an echo effect.
4. The computer-implemented method of any of clauses 1-3, wherein determining the first audio focal point comprises detecting at least one of an ear or a head of an occupant of the vehicle at the first instant in time, and wherein determining the second audio focal point comprises detecting the at least one of the ear or the head of the occupant of the vehicle at the second instant in time.
5. The computer-implemented method of any of clauses 1-4, wherein modifying the at least one parameter of the audio output of the first speaker comprises at least one of decreasing a volume of the audio output of the first speaker based on detecting a reduction in a separation distance between the first speaker and the occupant of the vehicle, increasing a delay of the audio output of the first speaker based on detecting the reduction in the separation distance between the first speaker and the occupant of the vehicle, or modifying a spectral characteristic of the audio output of the first speaker based on detecting the reduction in the separation distance between the first speaker and the occupant of the vehicle.
6. The computer-implemented method of any of clauses 1-5, further comprising at least one of increasing a volume of the audio output of a second speaker based on detecting the reduction in the separation distance between the first speaker and the occupant of the vehicle, decreasing a delay of the audio output of the second speaker based on detecting the reduction in the separation distance between the first speaker and the occupant of the vehicle, or modifying a spectral characteristic of the audio output of the second speaker based on detecting the reduction in the separation distance between the first speaker and the occupant of the vehicle.
7. The computer-implemented method of any of clauses 1-6, wherein detecting the at least one of the ear or the head of the occupant of the vehicle is based on evaluating one or more images of the occupant captured by one or more cameras in the vehicle.
8. The computer-implemented method of any of clauses 1-7, wherein detecting the at least one of the ear or the head of the occupant of the vehicle is based on evaluating one or more sensor signals provided by one or more sensors in the vehicle.
9. The computer-implemented method of any of clauses 1-8, wherein modifying the at least one parameter of the audio output of the first speaker comprises detecting at least one of a yaw, pitch, or roll of the head of the occupant of the vehicle with reference to an axis of travel of the audio output of the first speaker to the ear of the occupant, and modifying the at least one parameter of the audio output of the first speaker based on the at least one of the yaw, pitch, or roll of the head of the occupant.
10. The computer-implemented method of any of clauses 1-9, further comprising modifying at least one parameter of an audio output of a second speaker in the vehicle in inverse proportion to modifying the at least one parameter of the audio output of the first speaker in the vehicle.
11. The computer-implemented method of any of clauses 1-10, wherein modifying the at least one parameter of the audio output of the first speaker to produce the specific sound effect at the second audio focal point in the vehicle comprises modifying at least one of a volume, a delay, a phase characteristic, or a spectral characteristic of the audio output of the first speaker based on associating one or more audio focal points in the vehicle to one or more audio parameters.
12. The computer-implemented method of any of clauses 1-11, wherein modifying the at least one parameter of the audio output of the first speaker to produce the specific sound effect at the second audio focal point in the vehicle comprises referring to one of a look-up table or a database that provides a mapping of one or more audio focal points in the vehicle to one or more audio parameters.
13. The computer-implemented method of any of clauses 1-12, wherein the first audio focal point is a calibration reference position and wherein the second audio focal point corresponds one of an ear or a head of an occupant of the vehicle.
14. In some embodiments, one or more non-transitory computer-readable media store instructions that, when executed by one or more processors, cause the one or more processors to perform the steps of determining a first audio focal point in a vehicle at a first instant in time, configuring at least one parameter of an audio output of a first speaker in the vehicle to produce a specific sound effect at the first audio focal point, determining a second audio focal point in the vehicle at a second instant in time, and modifying the at least one parameter of the audio output of the first speaker to produce the specific sound effect at the second audio focal point in the vehicle.
15. The one or more non-transitory computer-readable media of clause 14, wherein the at least one parameter of the audio output of the first speaker comprises at least one of a volume, a delay, a phase characteristic, or a spectral characteristic.
16. The one or more non-transitory computer-readable media of clauses 14 or 15, wherein the specific sound effect comprises at least one of a surround sound effect, an environmental sound effect, a directional sound effect, a tailored frequency effect, a reverb effect, or an echo effect.
17. The one or more non-transitory computer-readable media of any of clauses 14-16, wherein determining the first audio focal point comprises detecting at least one of an ear or a head of an occupant of the vehicle at the first instant in time, and wherein determining the second audio focal point comprises detecting the at least one of the ear or the head of the occupant of the vehicle at the second instant in time.
18. The one or more non-transitory computer-readable media of any of clauses 14-17, wherein detecting the at least one of the ear or the head of the occupant of the vehicle is based on evaluating one or more images of the occupant captured by one or more cameras in the vehicle.
19. The one or more non-transitory computer-readable media of any of clauses 14-18, wherein modifying the at least one parameter of the audio output of the first speaker comprises at least one of decreasing a volume of the audio output of the first speaker based on detecting a reduction in a separation distance between the first speaker and the occupant of the vehicle, increasing a delay of the audio output of the first speaker based on detecting the reduction in the separation distance between the first speaker and the occupant of the vehicle, or modifying a spectral characteristic of the audio output of the first speaker based on detecting the reduction in the separation distance between the first speaker and the occupant of the vehicle.
20. In some embodiments, a system comprises one or more speakers, a memory storing an audio adjuster application, and a processor coupled to the memory that executes the audio adjuster application by performing the steps of determining a first audio focal point in a vehicle at a first instant in time, configuring at least one parameter of an audio output of a first speaker in the vehicle to produce a specific sound effect at the first audio focal point, determining a second audio focal point in the vehicle at a second instant in time, and modifying the at least one parameter of the audio output of the first speaker to produce the specific sound effect at the second audio focal point in the vehicle.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium having computer readable program code embodied thereon.

Any combination of one or more computer readable medium can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function. It should also be noted that, in some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for performing audio adjustments in a vehicle based on different audio focal points in the vehicle, the computer-implemented method comprising:
determining a first audio focal point in the vehicle at a first instant in time;
configuring at least one parameter of an audio output of a first speaker in the vehicle to produce a specific sound effect at the first audio focal point;
determining a second audio focal point in the vehicle at a second instant in time; and
modifying the at least one parameter of the audio output of the first speaker to produce the specific sound effect at the second audio focal point in the vehicle.

2. The computer-implemented method of claim 1, wherein the at least one parameter of the audio output of the first speaker comprises at least one of a volume, a delay, a phase characteristic, or a spectral characteristic.

3. The computer-implemented method of claim 1, wherein the specific sound effect comprises at least one of a surround sound effect, an environmental sound effect, a directional sound effect, a tailored frequency effect, a reverb effect, or an echo effect.

4. The computer-implemented method of claim 1, wherein determining the first audio focal point comprises detecting at least one of an ear or a head of an occupant of the vehicle at the first instant in time, and wherein determining the second audio focal point comprises detecting the at least one of the ear or the head of the occupant of the vehicle at the second instant in time.

5. The computer-implemented method of claim 4, wherein modifying the at least one parameter of the audio output of the first speaker comprises at least one of decreasing a volume of the audio output of the first speaker based on detecting a reduction in a separation distance between the first speaker and the occupant of the vehicle, increasing a delay of the audio output of the first speaker based on detecting the reduction in the separation distance between the first speaker and the occupant of the vehicle, or modifying a spectral characteristic of the audio output of the first speaker based on detecting the reduction in the separation distance between the first speaker and the occupant of the vehicle.

6. The computer-implemented method of claim 5, further comprising at least one of increasing a volume of the audio output of a second speaker based on detecting the reduction in the separation distance between the first speaker and the occupant of the vehicle, decreasing a delay of the audio output of the second speaker based on detecting the reduction in the separation distance between the first speaker and the occupant of the vehicle, or modifying a spectral characteristic of the audio output of the second speaker based on detecting the reduction in the separation distance between the first speaker and the occupant of the vehicle.

7. The computer-implemented method of claim 4, wherein detecting the at least one of the ear or the head of the occupant of the vehicle is based on evaluating one or more images of the occupant captured by one or more cameras in the vehicle.

8. The computer-implemented method of claim 4, wherein detecting the at least one of the ear or the head of the occupant of the vehicle is based on evaluating one or more sensor signals provided by one or more sensors in the vehicle.

9. The computer-implemented method of claim 4, wherein modifying the at least one parameter of the audio output of the first speaker comprises:
detecting at least one of a yaw, pitch, or roll of the head of the occupant of the vehicle with reference to an axis of travel of the audio output of the first speaker to the ear of the occupant; and
modifying the at least one parameter of the audio output of the first speaker based on the at least one of the yaw, pitch, or roll of the head of the occupant.

10. The computer-implemented method of claim 1, further comprising modifying at least one parameter of an audio output of a second speaker in the vehicle in inverse proportion to modifying the at least one parameter of the audio output of the first speaker in the vehicle.

11. The computer-implemented method of claim 1, wherein modifying the at least one parameter of the audio output of the first speaker to produce the specific sound effect at the second audio focal point in the vehicle comprises modifying at least one of a volume, a delay, a phase characteristic, or a spectral characteristic of the audio output of the first speaker based on associating one or more audio focal points in the vehicle to one or more audio parameters.

12. The computer-implemented method of claim 1, wherein modifying the at least one parameter of the audio output of the first speaker to produce the specific sound effect at the second audio focal point in the vehicle comprises referring to one of a look-up table or a database that provides a mapping of one or more audio focal points in the vehicle to one or more audio parameters.

13. The computer-implemented method of claim 1, wherein the first audio focal point is a calibration reference position and wherein the second audio focal point corresponds one of an ear or a head of an occupant of the vehicle.

14. One or more non-transitory computer-readable media storing instructions that, when executed by one or more processors, cause the one or more processors to perform the steps of:
determining a first audio focal point in a vehicle at a first instant in time;
configuring at least one parameter of an audio output of a first speaker in the vehicle to produce a specific sound effect at the first audio focal point;
determining a second audio focal point in the vehicle at a second instant in time; and
modifying the at least one parameter of the audio output of the first speaker to produce the specific sound effect at the second audio focal point in the vehicle.

15. The one or more non-transitory computer-readable media of claim 14, wherein the at least one parameter of the audio output of the first speaker comprises at least one of a volume, a delay, a phase characteristic, or a spectral characteristic.

16. The one or more non-transitory computer-readable media of claim 14, wherein the specific sound effect comprises at least one of a surround sound effect, an environmental sound effect, a directional sound effect, a tailored frequency effect, a reverb effect, or an echo effect.

17. The one or more non-transitory computer-readable media of claim 14, wherein determining the first audio focal point comprises detecting at least one of an ear or a head of an occupant of the vehicle at the first instant in time, and wherein determining the second audio focal point comprises detecting the at least one of the ear or the head of the occupant of the vehicle at the second instant in time.

18. The one or more non-transitory computer-readable media of claim 17, wherein detecting the at least one of the ear or the head of the occupant of the vehicle is based on evaluating one or more images of the occupant captured by one or more cameras in the vehicle.

19. The one or more non-transitory computer-readable media of claim 17, wherein modifying the at least one parameter of the audio output of the first speaker comprises at least one of decreasing a volume of the audio output of the first speaker based on detecting a reduction in a separation distance between the first speaker and the occupant of the vehicle, increasing a delay of the audio output of the first speaker based on detecting the reduction in the separation distance between the first speaker and the occupant of the vehicle, or modifying a spectral characteristic of the audio output of the first speaker based on detecting the reduction in the separation distance between the first speaker and the occupant of the vehicle.

20. A system comprising:
one or more speakers;
a memory storing an audio adjuster application; and
a processor coupled to the memory that executes the audio adjuster application by performing the steps of:
determining a first audio focal point in a vehicle at a first instant in time;
configuring at least one parameter of an audio output of a first speaker in the vehicle to produce a specific sound effect at the first audio focal point;
determining a second audio focal point in the vehicle at a second instant in time; and
modifying the at least one parameter of the audio output of the first speaker to produce the specific sound effect at the second audio focal point in the vehicle.
